(19) United States
(12) Patent Application Publication
(10) Pub. No.: US 2006/0150335 A1
(43) Pub. Date: Jul. 13, 2006

(54) Rescue cocoon

(76) Inventors: Thomas Wilhelmus Dankbaar, Heel (NL); Johannus Hendrikus Hubertus Oitmann, Herkenbosch (NL)

Correspondence Address: HOFFMANN & BARON, LLP, 6900 JERICHO TURNPIKE, SYOSSET, NY, 11791, US

(21) Appl. No.: 11/134,231

(22) Filed: May 20, 2005

(30) Foreign Application Priority Data
Nov. 24, 2004 (EP) EP 04078199.9

(51) Int. Cl. A61G 1/00

(52) U.S. Cl. 5/629

(57) ABSTRACT

A method for rescuing a person who is for instance injured and/or unconscious, from an in particular relatively confined chamber with a relatively small entrance opening such as a conduit provided with a manhole, wherein the person is included in stretched-out condition in an elongated, rigid holder which encloses the person at least virtually completely whereupon the holder with the person included therein is transported outside the chamber via the entrance opening.

The invention relates to a method for rescuing a person who is for instance injured and/or unconscious, from an in particular relatively confined chamber with a relatively small entrance opening such a conduit provided with a manhole.

The invention also relates to an assembly comprising an in particular relatively confined chamber with a relatively small entrance opening such as a conduit provided with a manhole and a holder for rescuing a person who is, for instance, injured and/or unconscious from the confined chamber.

The invention also relates to a holder for rescuing a person who is, for instance, injured and/or unconscious from an in particular relatively confined chamber with a relatively small entrance opening such as a conduit provided with a manhole.

Such a method, assembly and holder are known per se from, for instance, U.S. Pat. No. 5,745,938.

It happens that persons having to carry out operations in a chamber that is confined for this person and having, for this person, a relatively small entrance opening such as a conduit provided with a manhole, meet with an accident or become unwell. Here, for instance, horizontally directed steam cylinders forming part of an apparatus for manufacturing paper from pulp can be involved. In use, such cylinders are heated at their inner sides with steam. When a person is to carry out an inspection or operations in such a cylinder, first of all, the supply of steam to the cylinder must be stopped so that the cylinder can cool down somewhat. After it has cooled down to a temperature of, for instance, below 40° C., the person can squeeze himself in via a manhole often situated at the end face of the cylinder. However, during inspection, it may occur that the person injures himself or becomes unwell. Especially when the temperature is still high, in such a confined chamber it may occur that the person looses consciousness.

With the known method, the respective person is placed on a stretcher by emergency personnel present in or outside the confined chamber or entering or leaving the confined chamber. Then, one end of the stretcher is connected to a part of the inner side of the confined chamber near the relatively small opening. As the opening is often situated at a certain height in the chamber, the stretcher will start making an angle relative to the horizon. As a result, the person is in danger of sliding from the stretcher. This could be solved by roping the person, however, this is often difficult to carry out if the respective person has particular injuries. Then, the stretcher is brought to a horizontal position so that the stretcher comes to lie in alignment with an underside of the opening. After this, the person to be rescued is to be slid over the stretcher and outside through the opening. This, too, entails a number of difficulties. If the person is roped, first of all, he has to be freed again. Then, the person is to be pushed through the opening. Especially when the person is unconscious, this is awkward because the body is limp. Moreover, the head and the limbs of the person can become trapped in the opening. When the person is slid outwards, he then has to be received on, for instance, a standard stretcher which has been brought to the altitude of the entrance opening at an outer side of the chamber. This, too, is difficult, requires time (every second counts in case of an emergency) and is a further source of accidents.

The method according to the invention contemplates providing a solution to at least a number of the drawbacks mentioned. Accordingly, the method according to the invention is characterized in that the person is included in stretched-out position in an elongated, rigid holder enclosing the person at least virtually completely whereupon the holder with the person included therein is transported outside the chamber via the entrance opening. As the holder encloses the person virtually completely, the person can be transported through the confined chamber in a simple manner. This can be carried out by other persons, hereinafter to be called rescue workers. Here, the rescue workers do not have to concern themselves with, for instance, limp limbs of the person, which may dangle. Moreover, there is no risk that during transport in the chamber, the person to be rescued is knocked against an inside wall. Further, the holder can simply be slid through the opening. This can be done rapidly without this sliding out of the person being complicated in that for instance, the body is limp. Furthermore, injuries to the person while being slid outside, for instance by an edge of the opening or the manhole, are prevented. Also, the optional lifting of the holder required for sliding it outside through the opening can be carried out rapidly and readily. When the holder is slid outside through the opening it can simply be received at the outside and then, for instance, be laid on the ground. After this, the person can be taken from the holder and be nursed further.

In particular, use is made of a holder which is provided with an elongated carrier part and a lid removable from the carrier part. When the lid has been removed, the person can be laid down on the elongated carrier part. After this, the lid can be placed on the carrier part so that the person is at least virtually completely enclosed by the holder. Here, it preferably holds that the carrier part and the lid are interconnected at least by means of at least one quick acting closure for closing the lid on the carrier part on which the person rests. For opening the holder, it may be so that the lid is detachably connected to the carrier part. The lid can then be completely removed from the carrier part for placing the person in the holder or, conversely, for removing the person from the holder. It is also possible that the lid is connected to the carrier part by means of a hinge joint connection. This allows the holder to be opened rapidly to then place the person on the carrier part rapidly and easily. Thereupon, the cover can be closed rapidly so that the holder can be brought out of the chamber in closed condition via the opening.

Preferably, it holds that the carrier part has the form of an elongated dish. More in particular, it holds that a height of the dish is greater than the height of the lid. The holder can further be provided with, optionally, removable handles. The rescue worker or rescue workers wanting to carry out the rescue can easily transport the holder by seizing hold of the handles. Preferably, it holds that the holder has, substantially, the shape of an elongated cylinder with a cross section having substantially the shape of an oval. This cross section entails that the shape of the holder is adjusted to the shape of the human body which entails that a surface of the cross section can be arranged with a relatively small size. In particular it further holds that the holder is provided with at least one air hole. It also holds in particular that the person, the head of the person included, is at least virtually completely enclosed by the holder. An outer wall of the holder can be manufactured at least virtually completely from a metal such as, for instance, aluminum and/or a plastic.

The assembly according to the invention is characterized in that the holder is designed as an elongated rigid holder designed for receiving, in use, a person in stretched-out condition such that the person is at least virtually completely enclosed by the holder, the holder having dimensions such that it can be inserted through the entrance opening for bringing the holder from the inside to the outside of the chamber. The holder according to the invention is characterized in that the holder is designed as an elongated rigid holder designed for receiving, in use, a person in stretched-out condition such that the person is at least virtually completely enclosed by the holder.

The invention will presently be further elucidated with reference to the drawing. In the drawing:

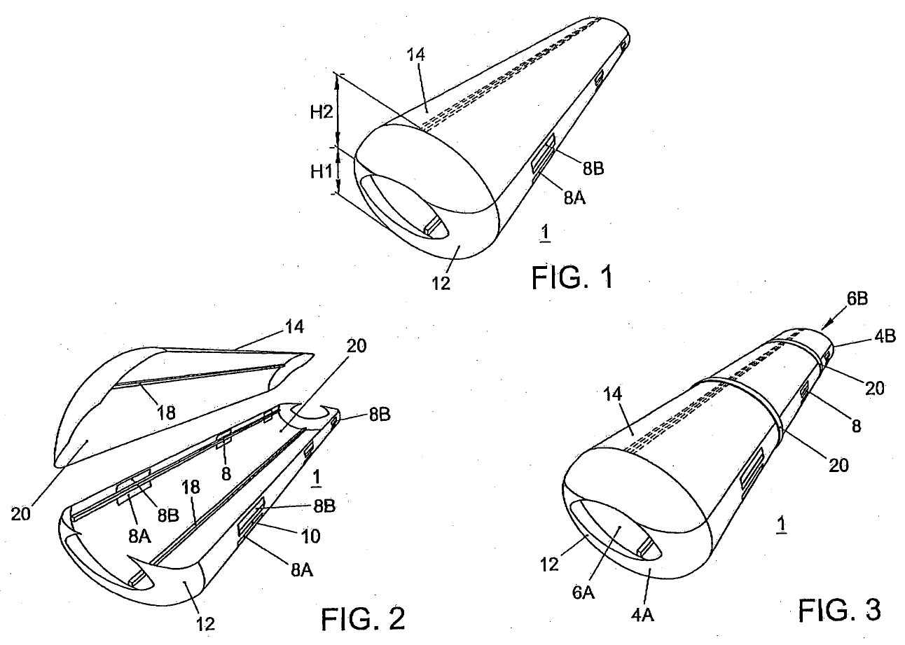

FIG. 1 shows a possible embodiment of a holder according to the invention for carrying out a method according to the invention;

FIG. 2 shows the holder according to FIG. 1 in opened condition;

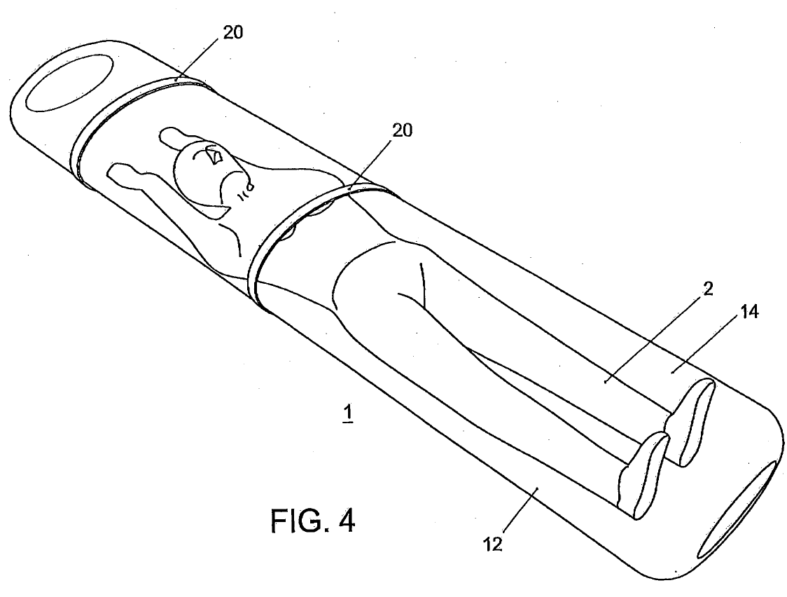

FIG. 3 shows the holder according to FIG. 1 in locked condition;

FIG. 4 shows a transparent view of the holder according to FIG. 1 in which a person to be rescued has been included;

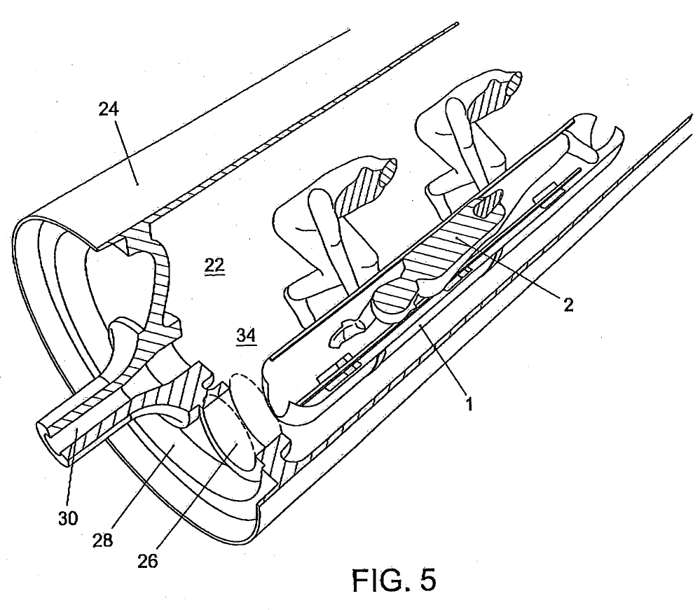

FIG. 5 shows an assembly according to the invention comprising a chamber and a holder according to FIG. 1 in which a person to be rescued has been included;

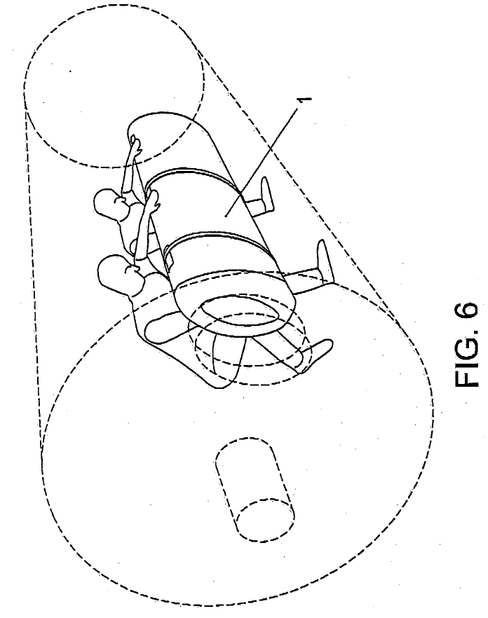

FIG. 6 shows the assembly according to FIG. 5 during the rescue of a person;

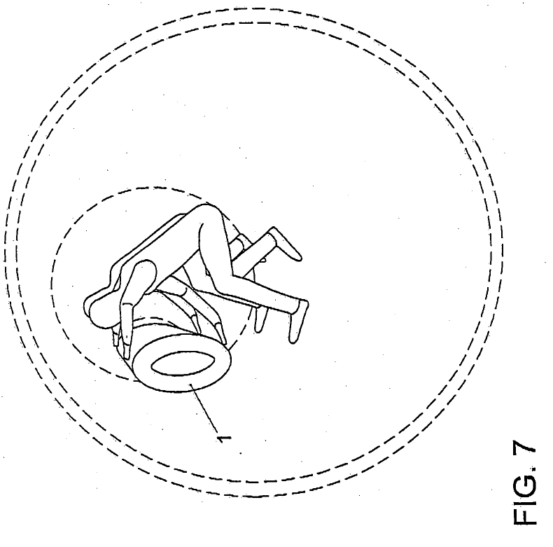

FIG. 7 shows the assembly according to FIG. 5 while the holder according to FIG. 1 is slid through a manhole of the chamber;

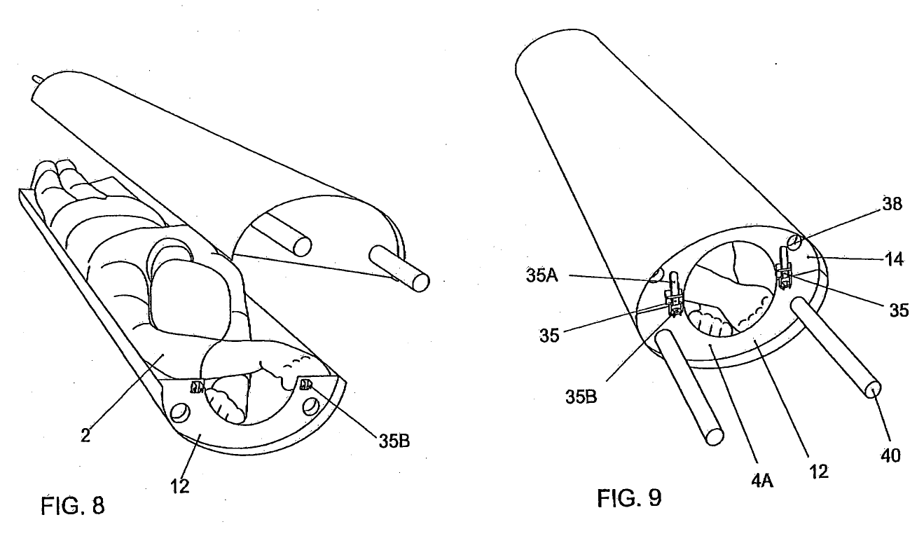

FIG. 8 shows a second embodiment of a holder according to the invention in which the person to be rescued has been included;

FIG. 9 shows the holder according to FIG. 8 in closed condition;

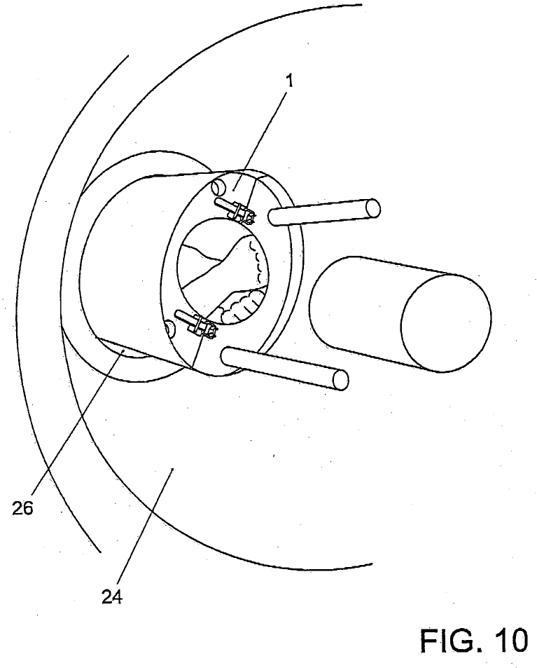

FIG. 10 shows the holder according to FIG. 9 with a person included therein which holder is slid outside through a manhole of a cylinder;

FIG. 11 shows a third embodiment of a holder according to the invention; and

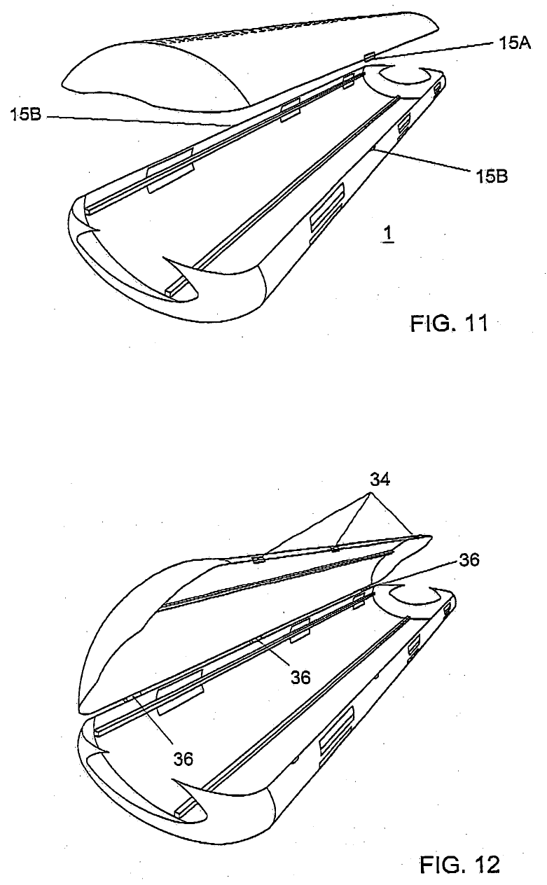

FIG. 12 shows a fourth embodiment of a holder according to the invention.

FIGS. 1-7 show, with reference numeral 1, a holder for rescuing a person who is for instance injured and/or unconscious, from a chamber with a relatively small entrance opening. In this example, a relatively small entrance opening means that the opening is relatively small for a grown-up to crawl through. In this example, the chamber is a relatively confined chamber. This means that the chamber is relatively confined for a grown-up. This may mean, for instance, that the chamber has a particular linear measure (length, width, height and/or diameter) which is smaller than the length of a grown-up. The holder 1 is designed as an elongated rigid holder designed to receive, in use, a person 2 (see FIG. 4) in stretched-out condition. As is clearly shown in FIG. 4, the person in this example is at least virtually completely enclosed by the holder. The head of the person too is at least virtually completely enclosed by the holder. At the end faces 4A, 4B, the holder is provided with air supply openings 6a, 6b. Further, the holder is provided at the sides of the holder with a number of openings 8. As can be seen in FIG. 1, these openings are situated in pairs 8a, 8b, one above the other. The partition wall 10 between the openings 8a, 8b can function as handle while the openings 8a, 8b themselves can also serve as air holes.

As is clearly shown in FIG. 2, the holder is provided with an elongated carrier part 12 and with a lid 14 detachable from the carrier part. In the example of FIGS. 1-7, the lid 14 is detachably connected to the carrier part 12. The carrier part 12 (see FIG. 2) has the shape of an elongated dish. A height H1 of the dish 12 is greater than a height H2 of the lid 14. As can be clearly seen in FIG. 1 and FIG. 6, the holder has substantially the form of an elongated cylinder with a cross section having substantially the form of an oval.

In this example, the holder is provided with reinforcement ribs 18. An outer wall 20 of the holder can for instance be manufactured at least virtually completely from a metal and/or a plastic, more in particular from a light yet strong material such as aluminum and/or plastic. In order to interconnect the carrier part 12 and the lid 14, use can be made of straps 20 as shown in FIG. 3.

A method for rescuing a person with the holder 1 as described hereinabove from a confined chamber with a relatively small entrance opening can be carried out as follows.

In this example, the confined chamber 22 from which the person 2 is to be rescued involves a chamber formed by a conduit or cylinder 24 which is provided with a manhole 26 forming the entrance opening mentioned. The cylinder 24 is directed horizontally. In this example, the cylinder is a steam cylinder, for instance a steam cylinder of an apparatus for manufacturing paper. In FIG. 5 is shown a first end 28 of the cylinder, provided with the respective manhole of the cylinder. At another end (not shown) of the cylinder 24, the cylinder is provided with a same end 28 without a manhole 26. In this example, it holds that the opening, viz. the manhole, has a greatest diameter of 60 cm, more in particular a greatest diameter of 39 cm.

As can be seen in FIG. 5, the end 28 is provided with a supply opening 30 for the supply of steam. This steam is discharged again at the other side of the cylinder via a comparable supply opening 30. Thus, the cylinder 24 is heated by steam flowing during use through the cylinder. However, from time to time, the cylinder 24 is to be cleaned and/or inspected. To this end, the steam supply and steam discharge via the openings 30 is stopped so that the cylinder can cool down, for instance to below 40° C. Then, a person wanting to clean and/or inspect the cylinder enters the cylinder via the manhole 26. In FIG. 5, the cylinder is shown with a quarter cut away. The holder is shown with one half cut away. The contours of the cut-away part of the man hole 26 are represented with dots. In this example, it is assumed that a person 2 becomes unwell in this cylinder. In this example, person 2 is for instance unconscious. To rescue the person 2, the holder 1 is slid via the manhole into the cylinder by at least one or preferably at least two persons further to be indicated as rescue workers 32. Here, it can be such that the holder is slid into the cylinder in closed condition as shown in FIG. 3 or 4. However, it is also possible that for instance first, the carrier part 12 is slid inside via the manhole, and then the lid 14.

Then, the person 2 to be rescued is laid on the carrier part 12 in stretched-out condition. In this example, the person is laid on his back. Other positions, such as lying the person to be rescued on his stomach or side are possible as well. Here, the carrier part 12 rests, for instance, on a bottom 34 of the cylinder. When the person 2 to be rescued lies on the carrier part 12, the rescue workers 32 place the lid 14 on the carrier part. The result is that the person is at least virtually completely enclosed by the holder. After this, carrier part 12 and the lid 14 can be fixedly connected with each other by means of, for instance, the straps 20. The person is then in a situation as shown in FIG. 4. Thereupon, the rescue workers 32 take up the stretcher 1, for instance by the earlier mentioned handles (see FIG. 6). The rescue workers 32 then transport the holder through the cylinder to the manhole 26. In this example, a cross section of the manhole has a form that substantially corresponds with a cross section of the holder. The fact is that both are of oval shaped design. Here, a cross section of the holder is only just smaller than the manhole. Therefore, it holds that the holder has dimensions such that it can be inserted through the entrance opening for bringing the holder from the inside to the outside of the chamber. In other words, in the assembly for holder and chamber, the holder and the chamber with the entrance opening are adjusted to each other. It further holds in this example that the holder has dimensions such that the entrance opening encompasses the holder snugly when the holder is inserted through the entrance opening. Thus, the adjustment mentioned is carried out even more precisely. As, in this example, the longitudinal axis of the manhole 26 is directed horizontally, the holder is positioned relative to the manhole 26 such that a longitudinal axis of the cross section of the holder is also directed vertically. Then, the holder is inserted by the rescue workers into the manhole 26 whereupon it is transported through the manhole out of the cylinder. The holder can be received by a rescue worker at an outside of the cylinder.

Sliding the holder through a manhole can be carried out relatively easily. It is not possible that the head or other body parts of the person get stuck behind the relatively tight manhole. Once the holder has been brought outside the cylinder, it can be opened whereupon the person 2 can be treated further.

The invention is not limited in any manner to the holder, method for rescuing a person with the aid of the holder and/or the assembly of holder and cylinder outlined hereinabove. For instance, the holder can be provided with a quick acting closure 35 for interconnecting the carrier part 12 and the lid 14. FIG. 11 shows such a known quick acting closure 35, of which a movig part 35a is attached to the lid and a fixed part 35b is attached to the carrier part 12. Here, for instance, quick acting closures of a type used with preserving jars can be considered. At the other longitudinal side of the holder such a quick acting closure 3,5 is provided too.

It is further possible that the lid 14 is connected to the carrier part 12 by means of hinges 36. Such a situation is shown in FIG. 12. On a side opposite the side where the holder is provided with the hinges 36, the holder is further provided with quick acting closures 35 as discussed in relation to FIG. 11. An advantage of the device of FIG. 12 is that opening and closing the holder can be carried out relatively rapidly. An advantage of the holder according to FIG. 1, wherein the lid is detachably connected to the carrier part and can be completely removed, is that situations are conceivable in which the person to be rescued can be easily manoeuvred onto the carrier part 12 when the lid 14 has been removed from the carrier part.

In FIGS. 8-10, a different embodiment of a holder according to the invention is shown-while parts corresponding with the preceding figures are provided with the same reference numerals. In this example, at the end face of the holder, further openings 38 are provided in which, in use, bars 40 can be inserted serving as handle. Therefore, removable handles are involved here. Also, on both end faces 4a and 4b, quick detachable couplings 35a, 35b are provided for interconnecting the lid 14 and the carrier part 12. This variant is not provided with hinges so that the lid can be completely removed from the carrier part for the purpose of placing, during use, the person 2 on the carrier part. As can be clearly seen in FIG. 10, it holds that the holder can be manipulated through the manhole 26 of the cylinder 24 in a snugly fitting manner. If the manhole has a circular instead of an oval form, a cross section of the holder can also be of circular design. Further, the invention is not limited to a relatively confined chamber. The method, the assembly and the holder can also relate to a relatively large chamber provided with a relatively small entrance opening. Such variants are each understood to fall within the framework of the invention.

1. A method for rescuing a person who is for instance injured and/or unconscious, from an in particular relatively confined chamber with a relatively small entrance opening such as a conduit provided with a manhole, characterized in that the person is included in stretched-out condition in an elongated, rigid holder enclosing the person at least virtually completely whereupon the holder with the person included therein is transported outside the chamber via the entrance opening.

2. A method according to claim 1, characterized in that use is made of a holder which is provided with an elongated carrier part and a lid removable from the carrier part.

3. A method according to claim 2, characterized in that for including the person in the holder, the person is laid on the carrier part when the lid has been removed from the carrier part after which, subsequently, the carrier part is closed by the lid.

4. A method according to claim 3, characterized in that the carrier part and the lid are interconnected at least by means of at least one quick acting closure for closing the lid on the carrier part on which the person rests.

5. A method according to claim 2, characterized in that the lid is connected to the carrier part by means of a hinge joint connection.

6. A method according to claim 2, characterized in that the lid is detachably connected to the carrier part.

7. A method according to claim 2, characterized in that the carrier part has the form of an elongated dish.

8. A method according to claim 7, characterized in that a height of the dish is greater than a height of the lid.

9. A method according to claim 1, characterized in that the holder is provided with optionally removable handles.

10. A method according to claim 1, characterized in that rescuing is carried out by one, and preferably by two persons.

11. A method according to claim 1, characterized in that transporting the holder in which the person to be rescued has been included in the chamber to the opening is effected by at least one person gripping the holder by at least one handle of the holder.

12. A method according to claim 1, characterized in that the holder is provided with at least one air hole.

13. A method according to claim 1, characterized in that the holder has substantially the form of an elongated cylinder with a cross section having substantially the form of an oval.

14. A method according to claim 1, characterized in that the person, the head of the person included, is at least virtually completely enclosed by the holder, also when the person is grown-up.

15. A method according to claim 1, characterized in that an outer wall of the holder is manufactured at least virtually completely from a metal such as for instance aluminum and/or a plastic.

16. A method according to claim 1, characterized in that the person is rescued from a, for instance, horizontally directed cylinder.

17. A method according to claim 16, characterized in that the holder with the person included therein is brought outside the cylinder via a manhole forming an entrance opening which is provided in an end face of the cylinder.

18. A method according to claim 16 characterized in that the cylinder involves a steam cylinder, in particular a steam cylinder of an apparatus for manufacturing paper from pulp.

19. A method according to claim 1, characterized in that the manhole has the form of an oval.

20. A method according to claim 1, characterized in that the entrance opening has a greatest diameter of 60 cm, more in particular a greatest diameter of 39 cm.

21. A holder for carrying out a method according to claim 1.

22. An assembly comprising an in particular relatively confined chamber with a relatively small entrance opening such as a conduit provided with a manhole, and comprising a holder for rescuing a person who is for instance injured and/or unconscious from the chamber, characterized in that the holder is designed as an elongated, rigid holder designed for including, during use, the person in stretch-out condition such that the person is at least virtually completely enclosed by the holder, the holder having dimensions such that it can be inserted through the entrance opening for bringing the holder from inside the chamber to outside the chamber.

23. An assembly according to claim 22, characterized in that the holder has dimensions such that the entrance opening snugly encompasses the holder when the holder is inserted through the entrance opening.

24. An assembly according to claim 22, characterized in that the entrance opening has the form of an oval and that a cross section of the holder also has the form of an oval.

25. An assembly according to claim 22, characterized in that the holder is provided with an elongated carrier part and a lid removable from the carrier part.

26. An assembly according to claim 25, characterized in that the carrier part and the lid are interconnected at least by means of at least one quick acting closure.

27. An assembly according to claim 25, characterized in that the lid is connected to the carrier part at least by means of a hinge joint connection.

28. An assembly according to claim 25, characterized in that the lid is detachably connected to the carrier part.

29. An assembly according to claim 25, characterized in that the carrier part has the form of an elongated dish.

30. An assembly according to claim 25, characterized in that a height of the dish is greater than a height of the lid.

31. An assembly according to claim 22, characterized in that the holder is provided with optionally removable handles.

32. An assembly according to claim 22, characterized in that the holder is provided with at least one air hole.

33. An assembly according to claim 22, characterized in that the holder has substantially the form of an elongated cylinder with a cross section having substantially the form of an oval.

34. An assembly according to claim 22, characterized in that the holder is designed such that a grown-up, a head of the person included, who is present in stretched-out condition the holder is at least virtually completely enclosed by the holder.

35. An assembly according to claim 22, characterized in that an outer wall of the holder is manufactured at least virtually completely from a metal such as aluminum and/or a plastic.

36. An assembly according to claim 22, characterized in that the chamber is formed by a cylinder in particular directed horizontally.

37. An assembly according to claim 36, characterized in that a manhole has been provided in an end face of the cylinder.

38. An assembly according to claim 36, characterized in that the cylinder involves a steam cylinder, in particular a steam cylinder of an apparatus for manufacturing paper from pulp.

39. An assembly according to claim 22, characterized in that the entrance opening has a greatest diameter of 60 cm, more in particular, a greatest diameter of 39 cm.

40. A holder for rescuing a person who is for instance injured or unconscious, from an in particular relatively confined chamber with a relatively small entrance opening such as a conduit provided with a manhole, characterized in that the holder is designed as an elongated, rigid holder designed for including, during use, the person in stretched-out condition such that the person is at least virtually completely enclosed by the holder.

41. A holder according to claim 40, characterized in that the holder is provided with an elongated carrier part and with a lid removable from the carrier part.

42. A holder according to claim 41, characterized in that the carrier part and the lid are interconnected at least by means of at least one quick acting closure.

43. A holder according to claim 41, characterized in that the lid is connected to the carrier part at least by means of one hinge joint connection.

44. A holder according to claim 41, characterized in that the lid is detachably connected to the carrier part.

45. A holder according to claim 41, characterized in that the carrier part has the form of an elongated dish.

46. A holder according to claim 41, characterized in that a height of the dish is greater than a height of the lid.

47. A holder according to claim 40, characterized in that a holder is provided with optionally removable handles.

48. A holder according to claim 40, characterized in that the holder is provided with at least one air hole.

49. A holder according to claim 40, characterized in that the holder has substantially the form of an elongated cylinder with a cross section having substantially the form of an oval.

50. A holder according to claim 40, characterized in that the holder is designed such that a grown-up, a head of the person included, who is present in the holder in stretched-out condition is at least virtually completely enclosed by the holder.

51. A holder according to claim 40, characterized in that an outer wall of the holder is manufactured at least virtually completely from a metal such as aluminum and/or a plastic.
